(19) United States
(12) Patent Application Publication
(10) Pub. No.: US 2023/0130712 A1
(43) Pub. Date: Apr. 27, 2023

(54) POSITIVE ACTIVE MATERIAL FOR ENERGY STORAGE DEVICE, POSITIVE ELECTRODE FOR ENERGY STORAGE DEVICE, ENERGY STORAGE DEVICE, AND ENERGY STORAGE APPARATUS

(71) Applicant: GS Yuasa International Ltd., Kyoto-shi, Kyoto (JP)

(72) Inventors: Daisuke ENDO, Kyoto (JP); Naoki INOUE, Kyoto (JP); Takanori MAHARA, Kyoto (JP)

(21) Appl. No.: 17/909,473

(22) PCT Filed: Mar. 3, 2021
(86) PCT No.: PCT/JP2021/008035

§ 371 Date: Sep. 6, 2022

(30) Foreign Application Priority Data
Mar. 10, 2020 (JP) 2020-040916
Mar. 10, 2020 (JP) 2020-040935

(51) Int. Cl. H01M 4/58; H01M 4/62; H01M 10/0525

(52) U.S. Cl. CPC H01M 4/5825; H01M 4/625; H01M 10/0525; H01M 2004/021

(57) ABSTRACT

The positive active material for an energy storage device according to one aspect of the present invention has an olivine-type crystal structure, has a surface at least partially coated with carbon, and satisfies either (A) or (B) below. (A) a pore volume in a range of a pore size of 60 nm or more and 200 nm or less determined by a BJH method from a desorption isotherm using a nitrogen gas adsorption method is 0.05 cm³/g or more and 0.25 cm³/g or less, and a pore specific surface area in a range of a pore size of 10 nm or more and 200 nm or less using a nitrogen gas adsorption method is 5 m²/g or more; (B) a full width at half maximum ratio (200)/(131) of a peak corresponding to a (200) plane to a peak corresponding to a (131) plane by a powder X-ray diffraction method using a CuKα ray in a charged state is 1.10 or less.

### TECHNICAL FIELD

The present invention relates to a positive active material for an energy storage device, a positive electrode for an energy storage device, an energy storage device, and an energy storage apparatus.

### BACKGROUND ART

Nonaqueous electrolyte secondary batteries typified by lithium ion secondary batteries are widely used for electronic devices such as personal computers and communication terminals, motor vehicles, and the like since these secondary batteries have a high energy density. The nonaqueous electrolyte secondary batteries generally include a pair of electrodes, which are electrically separated from each other by a separator, and a nonaqueous electrolyte interposed between the electrodes, and are configured to allow ions to be transferred between the two electrodes for charge-discharge. Capacitors such as lithium ion capacitors and electric double-layer capacitors are also widely in use as energy storage devices except for the nonaqueous electrolyte secondary batteries.

In recent years, an olivine-type positive active material which is inexpensive and highly safe has attracted attention as a positive active material used in the energy storage device. Since this olivine-type positive active material has low electron conductivity, it is difficult to obtain a discharge capacity close to the theoretical capacity, but a technique of coating a surface with carbon for improving electron conductivity has been proposed (see Patent Document 1).

### PRIOR ART DOCUMENT

### Patent Document

Patent Document 1: JP-A-2008-034306

### SUMMARY OF THE INVENTION

### Problems to Be Solved by the Invention

However, in the case of being applied to a starting battery of a motor vehicle or the like, a high rate characteristic in a low temperature environment is required. Since the high rate characteristic in a low temperature environment is also affected by factors other than electron conductivity, even if the surface of the olivine-type positive active material is coated with carbon, sufficient characteristics may not be obtained.

The present invention has been made in view of the above circumstances, and an object of the present invention is to provide a positive active material for an energy storage device capable of increasing a capacity of the energy storage device during high rate discharge in a low temperature environment.

### Means for Solving the Problems

The positive active material for an energy storage device according to one aspect of the present invention has an olivine-type crystal structure, has a surface at least partially coated with carbon, and satisfies either (A) or (B) below.
(A) A pore volume in the range of a pore size of 60 nm or more and 200 nm or less determined by a BJH method from a desorption isotherm using a nitrogen gas adsorption method is 0.05 cm³/g or more and 0.25 cm³/g or less, and a pore specific surface area in the range of a pore size of 10 nm or more and 200 nm or less using a nitrogen gas adsorption method is 5 m²/g or more.
(B) A full width at half maximum ratio (200)/(131) of a peak corresponding to the (200) plane to a peak corresponding to the (131) plane by a powder X-ray diffraction method using a CuKa ray in a charged state is 1.10 or less.

### Advantages of the Invention

The positive active material for an energy storage device according to one aspect of the present invention can increase a capacity of the energy storage device during high rate discharge in a low temperature environment.

### BRIEF DESCRIPTION OF THE DRAWINGS

FIG. 1 is an external perspective view showing an energy storage device according to an embodiment of the present invention.

FIG. 2 is a schematic view illustrating an energy storage apparatus configured by aggregating a plurality of energy storage devices according to one embodiment of the present invention.

FIG. 3 is a graph showing a relationship between a pore volume and a discharge capacity ratio.

FIG. 4 is a graph showing a relationship between a pore specific surface area and a discharge capacity ratio.

FIG. 5 is a graph showing a relationship between a full width at half maximum ratio (200)/(131) of a peak and a discharge capacity ratio.

FIG. 6 is a graph showing a relationship between a full width at half maximum of a peak corresponding to the (131) plane and a power ratio.

### MODE FOR CARRYING OUT THE INVENTION

The positive active material for an energy storage device according to one aspect of the present invention has an olivine-type crystal structure, has a surface at least partially coated with carbon, and satisfies either (A) or (B) below.
(A) A pore volume in the range of a pore size of 60 nm or more and 200 nm or less determined by a BJH method from a desorption isotherm using a nitrogen gas adsorption method is 0.05 cm³/g or more and 0.25 cm³/g or less, and a pore specific surface area in the range of a pore size of 10 nm or more and 200 nm or less using a nitrogen gas adsorption method is 5 m²/g or more.
(B) A full width at half maximum ratio (200)/(131) of a peak corresponding to the (200) plane to a peak corresponding to the (131) plane by a powder X-ray diffraction method using a CuKa ray in a charged state is 1.10 or less. Alternatively, a full width at half maximum ratio (200)/(131) of a peak corresponding to the (200) plane to a peak corresponding to the (131) plane by a powder X-ray diffraction method using a CuKa ray in a charged state is 1.10 or less.

The positive active material for an energy storage device has a surface at least partially coated with carbon, has an olivine-type crystal structure, and satisfies the (A) above, that is, has a pore volume and a pore specific surface area in a specific range, thereby making it possible to increase a capacity of the energy storage device during high rate discharge in a low temperature environment. The reason for this is presumed as follows. Since the positive active material for an energy storage device has good electron conductivity because a surface at least partially is coated with carbon, the discharge capacity under a low temperature environment tends to be governed by diffusibility of lithium ion. The range of the pore size of 60 nm or more and 200 nm or less is a region into which the nonaqueous electrolyte easily permeates, and the pore volume in the range of the pore size is set to 0.05 cm³/g or more and 0.25 cm³/g or less and the pore specific surface area in the range of a pore size of 10 nm or more and 200 nm or less is set to 5 m²/g or more, whereby a pore structure that promotes penetration of the nonaqueous electrolyte can be obtained. As a result, it is presumed that the lithium ion diffusibility in the positive composite layer is improved. Therefore, the positive active material for an energy storage device can increase the capacity of the energy storage device during high rate discharge in a low temperature environment.

The positive active material for an energy storage device has a surface at least partially coated with carbon, has an olivine-type crystal structure, and satisfies the (B) above, that is, the full width at half maximum ratio (200)/(131) of a peak by a powder X-ray diffraction method using a CuKa ray in a charged state has a specific range, so that the capacity of the energy storage device during high rate discharge in a low temperature environment can be increased. The reason for this is presumed as follows. Since the positive active material for an energy storage device has good electron conductivity because a surface at least partially is coated with carbon, the discharge capacity under a low temperature environment tends to be governed by diffusibility of lithium ion. It is presumed that in the positive active material for an energy storage device, when the full width at half maximum ratio (200)/(131) of a peak by a powder X-ray diffraction method using a CuKa ray in a charged state has a specific range, the positive active material for an energy storage device has a crystal structure advantageous for diffusion of lithium ion in a solid phase, and as a result, high diffusibility of lithium ion is likely to be obtained even in a low temperature environment. Therefore, the positive active material for an energy storage device can increase the capacity of the energy storage device during high rate discharge in a low temperature environment.

When the positive active material for an energy storage device satisfies the (B) above, the full width at half maximum of a peak corresponding to the (131) plane in a discharged state by a powder X-ray diffraction method using a CuKa ray is preferably 0.110 or more and 0.155 or less. When the full width at half maximum of the peak corresponding to the (131) plane is in the above range, a region is obtained in which the particle size of a primary particle constituting a secondary particle falls within a moderately fine range, so that the diffusibility of lithium ion is further enhanced and the capacity of the energy storage device during high rate discharge in a low temperature environment can be further increased.

The positive active material for an energy storage device is preferably a compound represented by the following formula 1.

$${\text{LiFe}}_{\text{x}} {\text{Mn}}_{\text{(1-x)}} {\text{PO}}_{4} ( 0 \leq \text{x} \leq \text{1)}$$

When the positive active material contains iron, manganese or a combination thereof as a transition metal, charge-discharge capacity can be further increased.

The positive electrode for an energy storage device according to one aspect of the present invention contains the positive active material. Since the positive electrode for an energy storage device contains the positive active material, the capacity of the energy storage device during high rate discharge in a low temperature environment can be increased.

The energy storage device according to one aspect of the present invention includes the positive electrode. Since the energy storage device includes the positive electrode containing the positive active material, the energy storage device is excellent in high rate discharge performance in a low temperature environment.

The energy storage apparatus according to one aspect of the present invention includes a plurality of energy storage devices and includes one or more of the energy storage devices. Since the energy storage apparatus includes one or more of the energy storage devices, the energy storage apparatus is excellent in high rate discharge performance in a low temperature environment.

Hereinafter, a positive active material for an energy storage device, a positive electrode for an energy storage device, an energy storage device and an energy storage apparatus according to one embodiment of the present invention will be described in detail in order.

### Positive Active Material for Energy Storage Device

The positive active material for an energy storage device (hereinafter, also simply referred to as the positive active material.) has an olivine-type crystal structure. A compound having an olivine-type crystal structure has a crystal structure attributable to space group Pnma. The crystal structure attributable to space group Pnma means having a peak attributable to space group Pnma in an X-ray diffraction diagram. Examples of the compound having an olivine-type crystal structure include AMPO₄ (A is an alkali metal such as Li, Na, or K. M is a transition metal such as Fe, Mn, Co, or Ni.). Since the compound having an olivine-type crystal structure is a polyanion salt in which an oxygen extraction reaction from a crystal lattice does not easily proceed, the compound has high safety and is inexpensive.

The positive active material for an energy storage device is preferably a compound represented by the following formula 1.

$${\text{LiFe}}_{\text{x}} {\text{Mn}}_{\text{(1-x)}} {\text{PO}}_{4} ( 0 \leq \text{x} \leq \text{1)}$$

Therefore, the positive active material is preferably composed of lithium manganese phosphate (LiMnPO₄), lithium iron phosphate (LiFePO₄), lithium manganese iron phosphate (LiFeₓMn₁₋ₓPO₄, 0 < x < 1) or a combination thereof. When the positive active material contains iron, manganese or a combination thereof as a transition metal, charge-discharge capacity can be further increased.

The compound represented by the formula 1 is a phosphate compound containing manganese, iron or a combination thereof and lithium. The compound represented by the formula 1 may contain a transition metal element other than manganese and iron, or a typical element such as aluminum. However, the compound represented by the formula 1 is preferably substantially composed of manganese, iron or a combination thereof, lithium, phosphorus, and oxygen.

In the formula 1, the upper limit of the x is 1, and preferably 0.95. Also, the lower limit of the x is 0, and preferably 0.25. When the range of x is in the above range, more excellent life characteristics are obtained. Note that x may be substantially 1.

The average particle size of primary particles of the positive active material layer is, for example, preferably 0.01 µm or more and 0.2 µm or less, and more preferably 0.02 µm or more and 0.1 µm or less. By setting the average particle size of the primary particles of the compound represented by the formula 1 to the above range, the diffusibility of lithium ion in the positive composite layer is improved.

The average particle size of secondary particles of the positive active material layer is, for example, preferably 3 µm or more and 20 µm or less, and more preferably 5 µm or more and 15 µm or less. By setting the average particle size of the secondary particles of the compound represented by the formula 1 to the above range, production and handling are facilitated, and the diffusibility of lithium ion in the positive composite layer is improved.

The positive active material has a surface at least partially coated with carbon. The positive active material has a surface at least partially coated with carbon, so that electron conductivity can be improved. The content of carbon in the positive active material is preferably 0.5% by mass or more and 5% by mass or less. By setting the content of carbon to the above range, the electrical conductivity can be increased, and electrode density as well as capacity of the energy storage device can be increased.

When the positive active material satisfies the (A) above, the lower limit of the pore volume in the range of a pore size of 60 nm or more and 200 nm or less determined by a BJH method from a desorption isotherm using a nitrogen gas adsorption method is 0.05 cm³/g, and preferably 0.10 cm³/g. On the other hand, the upper limit of the pore volume is 0.25 cm³/g, and preferably 0.20 cm³/g. When the pore volume is in the above range, the energy storage device including the positive electrode containing the active material can increase the capacity during high rate discharge in a low temperature environment.

When the positive active material satisfies the (A) above, the lower limit of the pore specific surface area in the range of a pore size of 10 nm or more and 200 nm or less using a nitrogen gas adsorption method is 5 m²/g, and preferably 7 m²/g. When the pore specific surface area is in the above range, the energy storage device including the positive electrode containing the active material can increase the capacity during high rate discharge in a low temperature environment.

The pore volume in the range of a pore size of 60 nm or more and 200 nm or less and the pore specific surface area in the range of a pore size of 10 nm or more and 200 nm or less of the positive active material are calculated based on the following procedure.

When the pore volume and the pore specific surface area are measured, “autosorb iQ” and control analysis software “ASiQwin” manufactured by Quantachrome Instruments are used. 1.00 g of lithium-transition metal composite oxide that is a sample to be measured is placed in a sample tube for measurement, and vacuum-dried at 120° C. for 12 hours to sufficiently remove moisture in the measured sample. Next, by a nitrogen gas adsorption method using liquid nitrogen, isotherms on the adsorption side and the extraction side are measured in a relative pressure P/P0 (P0 = about 770 mmHg) range of 0 to 1. Then, the pore distribution and the pore specific surface area are calculated by calculation by a BJH method using the isotherm on the extraction side.

When the positive active material satisfies the (B) above, the upper limit of the full width at half maximum ratio (200)/(131) of a peak corresponding to the (200) plane to a peak corresponding to the (131) plane by a powder X-ray diffraction method using a CuKa ray in a charged state is 1.10, and preferably 1.08. It is presumed that when the upper limit of the full width at half maximum ratio (200)/(131) of the peak is the above value, the positive active material for an energy storage device has a crystal structure advantageous for diffusion of lithium ion in a solid phase, and as a result, high diffusibility of lithium ion is likely to be obtained even in a low temperature environment. Therefore, the positive active material can increase the capacity of the energy storage device during high rate discharge in a low temperature environment. The lower limit of the full width at half maximum ratio (200)/(131) of the peak is preferably 0.95, and more preferably 1.00. When the lower limit of the full width at half maximum ratio (200)/(131) of the peak is the above value, the capacity of the energy storage device during high rate discharge in a low temperature environment can be further increased.

When the positive active material satisfies the (B) above, the upper limit of the full width at half maximum of the peak corresponding to the (131) plane by a powder X-ray diffraction method using a CuKa ray in a discharged state is preferably 0.155, and more preferably 0.145. The lower limit of the full width at half maximum of the peak corresponding to the (131) plane is preferably 0.110, and more preferably 0.115. When the full width at half maximum of the peak corresponding to the (131) plane is in the above range, a region is obtained in which the particle size of a primary particle constituting a secondary particle falls within a moderately fine range, so that the diffusibility of lithium ion is further enhanced and the capacity of the energy storage device during high rate discharge in a low temperature environment can be further increased.

When the positive active material satisfies the (B) above, the upper limit of the full width at half maximum of the peak corresponding to the (200) plane by a powder X-ray diffraction method using a CuKa ray in a charged state is preferably 0.20. The lower limit of the full width at half maximum of the peak corresponding to the (200) plane is preferably 0.11. When the full width at half maximum of the peak corresponding to the (200) plane is in the above range, it is possible to further increase the capacity of the energy storage device during high rate discharge in a low temperature environment.

The powder X-ray diffraction peak using a CuKa ray in the positive active material belongs to orthorhombic space group Pnma. The full width at half maximum of the peak corresponding to the (200) plane by a powder X-ray diffraction method using a CuKa ray is determined from a diffraction peak present at 2θ = 29.7 ± 0.5° in an X-ray diffraction diagram using a CuKa ray. In addition, the full width at half maximum of the peak corresponding to the (131) plane by a powder X-ray diffraction method using a CuKa ray is similarly determined from a diffraction peak present at 2θ = 35.6 ± 0.5°.

The full width at half maximum of the diffraction peak of the positive active material is measured using an X-ray diffractometer (Rigaku Corporation, model: MiniFlex II). Specifically, the measurement is performed according to the following conditions and procedures. Radiation source is a CuKa ray, and acceleration voltage and current are 30 kV and 15 mA, respectively. A sampling width is 0.01 deg, a scanning time is 14 minutes (scanning speed is 5.0), a divergence slit width is 0.625 deg, a light receiving slit width is open, and a scattering slit is 8.0 mm. It is determined by full width at half maximums output by automatically analyzing the obtained X-ray diffraction data using “PDXL” that is attached software of the X-ray diffractometer. When the X-ray diffraction data is analyzed, a peak derived from Ka2 is not removed. Here, “background refinement” and “Auto” are selected in a work window of the PDXL software, and refinement is performed such that an intensity error between an actually measured pattern and a calculated pattern is 4000 or less. Background processing is performed by this refinement, and based on the result obtained by subtracting a baseline, a value of peak intensity of each diffraction line, a value of full width at half maximum, and the like are obtained.

In the measurement of the pore volume and the pore specific surface area of the positive active material, a powder before charge-discharge of the positive active material before preparation of the positive electrode is subjected to the measurement as it is.

When a measurement sample is collected from a positive electrode taken out from a disassembled energy storage device, before the energy storage device is disassembled, constant current discharge is performed up to a voltage, which is the lower limit of a designated voltage under an environment of 25° C., at a current value (0.1 C) that is ⅒ of a current value giving an amount of electricity equal to a nominal capacity of the energy storage device when the energy storage device is energized at a constant current for 1 hour. The energy storage device is disassembled, the positive electrode is taken out, and the positive electrode plate is cut into a sufficiently small area of about 1 to 4 cm². An energy storage device having a metal lithium electrode as a counter electrode is assembled using this positive electrode plate, and constant current discharge is performed at a current value of 10 mA per g of a positive composite until the voltage between terminals becomes 2.0 V under an environment of 25° C., so that the battery is adjusted to a fully discharged state. Then, the battery is disassembled again, and the positive electrode is taken out. The positive electrode taken out is sufficiently washed with dimethyl carbonate to remove a nonaqueous electrolyte attached on the positive electrode, and is dried at room temperature for an entire day and night, and the positive composite on a positive electrode substrate is then collected. The operations from the disassembly of the battery, and the washing and drying operations of the positive electrode are performed in an argon atmosphere having a dew point of -60° C. or lower.

The obtained composite powder is dispersed in a solvent such as N-methylpyrrolidone (NMP), and the binder (PVdF or the like) in the positive composite is removed. Further, the conductive agent is removed from the powder obtained by washing the powder with dimethyl carbonate and then drying the powder by air classification or the like. In the measurement of the pore volume and the pore specific surface area, the positive composite collected in this way is subjected to the measurement.

In the measurement of the positive active material in a discharged state by a powder X-ray diffraction method, a powder before charge-discharge of the positive active material before preparation of the positive electrode is subjected to measurement as it is.

When a measurement sample is collected from the positive electrode taken out by disassembling the energy storage device, the positive composite collected from the energy storage device adjusted to a completely discharged state with a metal lithium electrode as a counter electrode is subjected to measurement in the same procedure as in the measurement of the pore volume and the pore specific surface area.

On the other hand, in the measurement by the powder X-ray diffraction method in the charged state of the positive active material, in the same procedure as in the measurement of the pore volume and the pore specific surface area, an energy storage device having a metal lithium electrode as a counter electrode is adjusted to a completely discharged state, then constant current charge is performed at a current value of 0.1 C under an environment of 25° C. until a voltage between terminals reaches 3.6 V, and then constant voltage charge is performed at 3.6 V. With regard to the charge termination conditions, charge is performed until the current reaches 0.02 C. The positive electrode is taken out from the energy storage device, and the positive composite is collected and subjected to measurement.

### Method for Producing Positive Active Material for Energy Storage Device

The positive active material can be produced, for example, based on the following procedure.

While a mixed aqueous solution of FeSO₄ and MnSO₄ at an arbitrary ratio is added dropwise at a constant rate to a reaction case containing ion-exchanged water, an aqueous NaOH solution, an aqueous NH₃ solution and an aqueous NH₂NH₂ solution are added dropwise so that the pH that time maintains a constant value, thereby preparing a FeₓMn₁₋ₓ(OH)₂ precursor. Next, the prepared FeₓMn₁₋ₓ)(OH)₂ precursor is solid-phase mixed with LiH₂PO₄ and sucrose powder. Then, a positive active material having an olivine-type crystal structure, represented by the following formula 1, is prepared by firing under a nitrogen atmosphere.

$${\text{LiFe}}_{\text{x}} {\text{Mn}}_{\text{(1-x)}} {\text{PO}}_{4} ( 0 \leq \text{x} \leq \text{1)}$$

In the case of producing the positive active material satisfying the (A) above, the range of a pore size of 60 nm or more and 200 nm or less is a region into which the nonaqueous electrolyte easily permeates, and the pore volume in the range of the pore size is set to 0.05 cm³/g or more and 0.25 cm³/g or less and the pore specific surface area in the range of a pore size of 10 nm or more and 200 nm or less is set to 5 m²/g or more, whereby the positive active material can obtain a pore structure that promotes penetration of the nonaqueous electrolyte. The pore volume can be obtained by controlling the pH at the time of preparing the FeₓMn_{1-X}(OH)₂ precursor. The pH range is preferably 8 or more and 11 or less. When the pH exceeds 11, the pore size of the positive active material is too small, and the nonaqueous electrolyte may be unlikely to penetrate into the positive active material. In addition, by using NH₃ as a complexing agent and NH₂NH₂ as an antioxidant, the pore specific surface area of the positive active material can be set in a favorable range. When NH₃ and NH₂NH₂ are not used, the pore specific surface area of the positive active material is too small, and sufficient high rate discharge performance in a low temperature environment may not be obtained. As described above, in the method for producing the positive active material, a pore structure that promotes permeation of the nonaqueous electrolyte can be obtained by setting the pH range and using the NH₃ and NH₂NH₂. As a result, it is presumed that the lithium ion diffusibility in the positive composite layer is improved. Therefore, the positive active material for an energy storage device can increase the capacity of the energy storage device during high rate discharge in a low temperature environment.

In the case of producing the positive active material satisfying the (B) above, the full width at half maximum of the peak corresponding to the (131) plane and the full width at half maximum of the peak corresponding to the (200) plane by a powder X-ray diffraction method using a CuKa ray in a charged state of the positive active material can be obtained by controlling the NH₃ concentration. The range of NH₃ concentration is preferably 0.25 mol/dm³ or more and 1 mol/dm³ or less. When the NH₃ concentration exceeds 1 mol/dm³, the precursor may not be sufficiently precipitated as the target composition. On the other hand, when the NH₃ concentration is less than 0.25 mol/dm³, uniform element distribution in one particle may not be achieved. In addition, by using NH₂NH₂ as the antioxidant of the precursor, the full width at half maximum of the peak of the positive active material can be set in a favorable range. As described above, in the method for producing the positive active material, a crystal structure advantageous for diffusion of lithium ion in the solid phase can be obtained by setting the range of NH₃ concentration and using the NH₂NH₂. As a result, high diffusibility of lithium ion is likely to be obtained even in a low temperature environment. Therefore, the positive active material for an energy storage device can increase the capacity of the energy storage device during high rate discharge in a low temperature environment.

According to the positive active material for an energy storage device, the capacity of the energy storage device during high rate discharge in a low temperature environment can be increased.

### Positive Electrode for Energy Storage Device

The positive electrode for an energy storage device (hereinafter, also simply referred to as the positive electrode.) contains the positive active material. The positive electrode has a positive electrode substrate and a positive composite layer disposed directly or via an intermediate layer on the positive electrode substrate.

### Positive Electrode Substrate

The positive electrode substrate has conductivity. As the material of the substrate, metals such as aluminum, titanium, tantalum, and stainless steel, or alloys thereof are used. Among these, aluminum and aluminum alloys are preferable from the viewpoint of the balance among electric potential resistance, high conductivity, and cost. Also, examples of the form of the positive electrode substrate include a foil and a vapor deposited film, and a foil is preferable from the viewpoint of cost. In other words, an aluminum foil is preferable as the positive electrode substrate. Examples of the aluminum or aluminum alloy include A1085 and A3003 prescribed in JIS-H4160 (2006).

The average thickness of the positive electrode substrate is preferably 5 µm or more and 50 µm or less, and more preferably 10 µm or more and 40 µm or less. When the average thickness of the positive electrode substrate is within the above range, it is possible to enhance the energy density per volume of the energy storage device while increasing the strength of the positive electrode substrate. The “average thickness of the substrate” refers to a value obtained by dividing a cutout mass in cutout of a substrate having a predetermined area by a true density and a cutout area of the substrate, and the same applied to the negative electrode substrate.

### Positive Composite Layer

The positive composite layer contains the positive active material.

The positive composite layer may further contain a positive active material other than the positive active material having an olivine-type crystal structure. Such other positive active material can be appropriately selected from known positive active materials usually used for lithium ion secondary batteries and the like. However, the lower limit of the total content of the positive active material having an olivine-type crystal structure in all the positive active materials contained in the positive composite layer is preferably 90% by mass, and more preferably 99% by mass. By using only the positive active material having an olivine-type crystal structure substantially as the positive active material as described above, the effect of the present invention can be further enhanced.

As the known positive active material for a lithium ion secondary battery, a material capable of storing and releasing lithium ions is usually used. Examples of the known positive active material include lithium-transition metal composite oxides having an α-NaFeO₂-type crystal structure, lithium-transition metal oxides having a spinel-type crystal structure, polyanion compounds, chalcogenides, and sulfur. Examples of the lithium transition metal composite oxide having an α-NaFeO₂ type crystal structure include Li[LiₓNi_{1-X}]O₂ (0 ≤ x < 0.5), Li[LiₓNi_{Y}Co(_{1-x-Y})]O₂ (0 ≤ x < 0.5, 0 < y < 1), Li[LiₓCo₍₁₋ₓ₎]O₂ (0 ≤ x < 0.5), Li[LiₓNi_{Y}Mn_{(1-x-Y)}]O₂ (0 ≤ x < 0.5, 0 < y < 1), Li[LiₓNi_{Y}Mn_{β}Co_{(1-x-Y-β)}]O₂ (0 ≤ x < 0.5, 0 < y, 0 < β, 0.5 < y + β < 1), and Li[LiₓNi_{Y}Co_{β}A1_{(1-x-Y-β)}]O₂ (0 ≤ x < 0.5, 0 < y, 0 < β, 0.5 < y + β < 1). Examples of the lithium-transition metal composite oxides having a spinel-type crystal structure include LiₓMn₂O₄ and LiₓNi_{Y}Mn(_{2-Y})O₄. Examples of the polyanion compounds include Li₃V₂(PO₄)₃, Li₂MnSiO₄, and Li₂CoPO₄F. Examples of the chalcogenides include titanium disulfide, molybdenum disulfide, and molybdenum dioxide. Apart of atoms or polyanions in these materials may be substituted with atoms or anion species composed of other elements. The surfaces of these materials may be coated with other materials. In the positive composite layer, one of these materials may be used singly, or two or more thereof may be used in mixture as the known positive active material. In the positive composite layer, one of these compounds may be used singly, or two or more of these compounds may be used in mixture.

The content of the positive active material in the positive composite layer is not particularly limited, but the lower limit thereof is preferably 50% by mass, more preferably 80% by mass, and still more preferably 90% by mass. On the other hand, the upper limit of this content is preferably 99% by mass, and more preferably 98% by mass.

The positive composite layer contains optional components such as a conductive agent, a binder, a thickener, and a filler and the like as necessary.

### Conductive Agent

The conductive agent is not particularly limited as long as it is a material exhibiting conductivity. Examples of such a conductive agent include carbonaceous materials, metals, and conductive ceramics. Examples of the carbonaceous materials include graphitized carbon, non-graphitized carbon, and graphene-based carbon. Examples of the non-graphitized carbon include carbon nanofibers, pitch-based carbon fibers, and carbon black. Examples of the carbon black include furnace black, acetylene black, and ketjen black. Examples of the graphene-based carbon include graphene, carbon nanotubes (CNTs), and fullerene. Examples of the shape of the conductive agent include a powdery shape and a fibrous shape. As the conductive agent, one of these materials may be used singly or two or more of these materials may be used in mixture. These materials may be composited and used. For example, a material obtained by compositing carbon black with CNT may be used. Among these, carbon black is preferable from the viewpoint of electron conductivity and coatability, and in particular, acetylene black is preferable.

The content of the conductive agent in the positive composite layer is preferably 1% by mass or more and 10% by mass or less, and more preferably 3% by mass or more and 9% by mass or less. By setting the content of the conductive agent within the above range, the energy density of the energy storage device can be enhanced.

### Binder

Examples of the binder include thermoplastic resins such as fluororesin (polytetrafluoroethylene (PTFE), polyvinylidene fluoride (PVDF) and the like), polyethylene, polypropylene, and polyimide; elastomers such as ethylene-propylene-diene rubber (EPDM), sulfonated EPDM, styrenebutadiene rubber (SBR), and fluororubber; and polysaccharide polymers.

The content of the binder in the positive composite layer is preferably 1% by mass or more and 10% by mass or less, and more preferably 3% by mass or more and 9% by mass or less. When the content of the binder is in the above range, the positive active material can be stably held.

### Thickener

When an aqueous dispersion medium is used, a polysaccharide polymer such as carboxymethylcellulose (CMC) or methylcellulose is used as a thickener. Also, when the thickener has a functional group that is reactive with lithium, it is preferable to deactivate this functional group by methylation and the like in advance.

### Filler

The filler is not particularly limited. Examples of the filler include polyolefins such as polypropylene and polyethylene, inorganic oxides such as silicon dioxide, alumina, titanium dioxide, calcium oxide, strontium oxide, barium oxide, magnesium oxide and aluminosilicate, hydroxides such as magnesium hydroxide, calcium hydroxide and aluminum hydroxide, carbonates such as calcium carbonate, hardly soluble ionic crystals of calcium fluoride, barium fluoride, and barium sulfate, nitrides such as aluminum nitride and silicon nitride, and substances derived from mineral resources, such as talc, montmorillonite, boehmite, zeolite, apatite, kaolin, mullite, spinel, olivine, sericite, bentonite and mica, or artificial products thereof.

The positive composite layer may contain a typical nonmetal element such as B, N, P, F, Cl, Br or I, a typical metal element such as Li, Na, Mg, Al, K, Ca, Zn, Ga or Ge, or a transition metal element such as Sc, Ti, V, Cr, Mn, Fe, Co, Ni, Cu, Mo, Zr, Nb, Sn, Sr, Ba or W as a component other than the positive active material, the conductive agent, the binder, the thickener, and the filler.

### Intermediate Layer

The intermediate layer is a coating layer on the surface of the positive electrode substrate, and contains conductive particles such as carbon particles to decrease contact resistance between the positive electrode substrate and the positive active material layer. The configuration of the intermediate layer is not particularly limited, and the intermediate layer can be formed of, for example, a composition containing a resin binder and conductive particles.

### Energy Storage Device

The energy storage device according to one embodiment of the present invention has a positive electrode, a negative electrode, and a nonaqueous electrolyte. Hereinafter, a nonaqueous electrolyte secondary battery will be described as an example of the energy storage device. The positive electrode and the negative electrode usually form an electrode assembly in which the positive electrode and the negative electrode are alternately superposed by being stacked or wound with a separator interposed therebetween. This electrode assembly is housed in a case, and a nonaqueous electrolyte is filled in this case. The nonaqueous electrolyte is interposed between the positive electrode and the negative electrode. As the case, a known metal case, resin case or the like that is usually used as a case of a nonaqueous electrolyte secondary battery can be used.

### Positive Electrode

The positive electrode included in the energy storage device is as described above.

### Negative Electrode

The negative electrode includes a negative electrode substrate and a negative composite layer stacked directly or indirectly on at least one surface of the negative electrode substrate. The negative electrode may include an intermediate layer disposed between the negative electrode substrate and the negative composite layer.

### Negative Electrode Substrate

The negative electrode substrate exhibits conductivity. As the material of the negative electrode substrate, a metal such as copper, nickel, stainless steel, nickel-plated steel, or aluminum, or an alloy thereof is used. Among them, copper or a copper alloy is preferable. Examples of the negative electrode substrate include a foil and a vapor deposited film, and a foil is preferable from the viewpoint of cost. Therefore, the negative electrode substrate is preferably a copper foil or a copper alloy foil. Examples of the copper foil include rolled copper foil and electrolytic copper foil.

The average thickness of the negative electrode substrate is preferably 2 µm or more and 35 µm or less, more preferably 3 µm or more and 30 µm or less, still more preferably 4 µm or more and 25 µm or less, and particularly preferably 5 µm or more and 20 µm or less. When the average thickness of the negative electrode substrate is within the above range, it is possible to enhance the energy density per volume of a secondary battery while increasing the strength of the negative electrode substrate. The “average thickness of the substrate” refers to a value obtained by dividing a cutout mass in cutout of a substrate having a predetermined area by a true density and a cutout area of the substrate.

### Negative Composite Layer

The negative composite layer contains a negative active material. The negative composite layer contains optional components such as a conductive agent, a binder, a thickener, and a filler and the like as necessary. The optional components such as a conductive agent, a binder, a thickener, and a filler can be selected from the materials exemplified for the positive electrode.

The negative active material can be appropriately selected from known negative active materials. As the negative active material for a lithium ion secondary battery, a material capable of absorbing and releasing lithium ions is usually used. Examples of the negative active material include metallic Li; metals or metalloids such as Si and Sn; metal oxides or metalloid oxides such as a Si oxide, a Ti oxide, and a Sn oxide; titanium-containing oxides such as Li₄Ti₅O₁₂, LiTiO₂, and TiNb₂O₇; a polyphosphoric acid compound; silicon carbide; graphite, and carbon materials such as non-graphitic carbon such as hardly graphitizable carbon (hard carbon) and easily graphitizable carbon (soft carbon). Among these materials, graphite and non-graphitic carbon are preferable. In the negative composite layer, one of these materials may be used singly or two or more thereof may be used in mixture.

The “graphite” refers to a carbon material in which an average lattice spacing (d₀₀₂) of the (002) plane determined by an X-ray diffraction method before charge-discharge or in a discharged state is 0.33 nm or more and less than 0.34 nm. Examples of the graphite include natural graphite and artificial graphite.

The “non-graphitic carbon” refers to a carbon material in which the average lattice spacing (d₀₀₂) of the (002) plane determined by the X-ray diffraction method before charge-discharge or in the discharged state is 0.34 nm or more and 0.42 nm or less. Examples of the non-graphitic carbon include hardly graphitizable carbon and easily graphitizable carbon. Examples of the non-graphitic carbon include a resin-derived material, a petroleum pitch or a material derived from petroleum pitch, a petroleum coke or a material derived from petroleum coke, a plant-derived material, and an alcohol derived material. The “hardly graphitizable carbon” refers to a carbon material in which the d₀₀₂ is 0.36 nm or more and 0.42 nm or less. The “easily graphitizable carbon” refers to a carbon material in which the d₀₀₂ is 0.34 nm or more and less than 0.36 nm.

Here, the “discharged state” in the carbon material refers to a state where an open circuit voltage is 0.7 V or more in a unipolar battery using a negative electrode, containing a carbon material as a negative active material, as a working electrode and using metallic Li as a counter electrode. Since the potential of the metallic Li counter electrode in an open circuit state is substantially equal to an oxidation/reduction potential of Li, the open circuit voltage in the unipolar battery is substantially equal to the potential of the negative electrode containing the carbon material with respect to the oxidation/reduction potential of Li. That is, the fact that the open circuit voltage in the unipolar battery is 0.7 V or more means that lithium ions that can be occluded and released in association with charge-discharge are sufficiently released from the carbon material that is the negative active material.

The content of the negative active material in the negative composite layer is preferably 60% by mass or more and 99% by mass or less, and more preferably 90% by mass or more and 98% by mass or less. When the content of the negative active material is in the above range, it is possible to achieve both high energy density and productivity of the negative composite layer.

The negative composite layer may contain a typical nonmetal element such as B, N, P, F, Cl, Br, or I, a typical metal element such as Li, Na, Mg, Al, K, Ca, Zn, Ga, Ge, Sn, Sr, and Ba or a transition metal element such as Sc, Ti, V, Cr, Mn, Fe, Co, Ni, Cu, Mo, Zr, Ta, Hf, Nb, or W as a component other than the negative active material, the conductive agent, the binder, the thickener, and the filler.

### Intermediate Layer

The intermediate layer is a coating layer on the surface of the negative electrode substrate, and contains conductive particles such as carbon particles to reduce contact resistance between the negative electrode substrate and the negative active material layer. Similarly to the positive electrode, the configuration of the intermediate layer is not particularly limited and can be formed of, for example, a composition containing a resin binder and conductive particles.

### Nonaqueous Electrolyte

As the nonaqueous electrolyte, a known nonaqueous electrolyte normally used for a general nonaqueous electrolyte secondary battery (energy storage device) can be used. The nonaqueous electrolyte contains a nonaqueous solvent and an electrolyte salt dissolved in the nonaqueous solvent. The nonaqueous electrolyte may be a solid electrolyte or the like.

As the nonaqueous solvent, it is possible to use a known nonaqueous solvent typically used as a nonaqueous solvent of a general nonaqueous electrolyte for an energy storage device. Examples of the nonaqueous solvent include cyclic carbonate, chain carbonate, ester, ether, amide, sulfone, lactone, and nitrile. Among these, it is preferable to use at least the cyclic carbonate or the chain carbonate, and it is more preferable use the cyclic carbonate and the chain carbonate in combination. When the cyclic carbonate and the chain carbonate are used in combination, the volume ratio of the cyclic carbonate to the chain carbonate (cyclic carbonate : chain carbonate) is not particularly limited but is preferably from 5 : 95 to 50 : 50, for example.

Examples of the cyclic carbonate include ethylene carbonate (EC), propylene carbonate (PC), butylene carbonate (BC), vinylene carbonate (VC), vinylethylene carbonate (VEC), chloroethylene carbonate, fluoroethylene carbonate (FEC), difluoroethylene carbonate (DFEC), styrene carbonate, catechol carbonate, 1-phenylvinylene carbonate, and 1,2-diphenylvinylene carbonate, and among these, EC is preferable.

Examples of the chain carbonate include diethyl carbonate (DEC), dimethyl carbonate (DMC), ethyl methyl carbonate (EMC), and diphenyl carbonate, and among these, EMC is preferable.

As the electrolyte salt, it is possible to use a known electrolyte salt typically used as an electrolyte salt of a general nonaqueous electrolyte for an energy storage device. Examples of the electrolyte salt include a lithium salt, a sodium salt, a potassium salt, a magnesium salt, and an onium salt, and a lithium salt is preferable.

Examples of the lithium salt include inorganic lithium salts such as LiPF₆, LiPO₂F₂, LiBF₄, LiClO₄, and LiN(SO₂F)₂, and lithium salts having a hydrocarbon group in which hydrogen is replaced by fluorine, such as LiSO₃CF₃, LiN(SO₂CF₃)₂, LiN(SO₂C₂F₅)₂, LiN(SO₂CF₃)(SO₂C₄F₉), LiC(SO₂CF₃)₃ and LiC(SO₂C₂F₅)₃. Among these, an inorganic lithium salt is preferable, and LiPF₆ is more preferable.

The lower limit of the concentration of the electrolyte salt in the nonaqueous electrolyte is preferably 0.1 mol/dm³, more preferably 0.3 mol/dm³, still more preferably 0.5 mol/dm³, and particularly preferably 0.7 mol/dm³. On the other hand, the upper limit is not particularly limited, and is preferably 2.5 mol/dm³, more preferably 2.0 mol/dm³, and still more preferably 1.5 mol/dm³.

Other additives may be added to the nonaqueous electrolyte. As the nonaqueous electrolyte, a salt that is melted at normal temperature, an ionic liquid, or the like can also be used.

### Separator

As the separator, for example, a woven fabric, a nonwoven fabric, and a porous resin film and the like are used. Among them, a porous resin film is preferable from the viewpoint of strength, and a nonwoven fabric is preferable from the viewpoint of liquid retention property of the nonaqueous electrolyte solution. As a main component of the separator, a polyolefin such as polyethylene or polypropylene is preferable from the viewpoint of strength, and polyimide, aramid or the like is preferable from the viewpoint of resistance to oxidation and decomposition. These resins may be composited.

An inorganic layer may be disposed between the separator and the electrode. This inorganic layer is a porous layer, which is also called a heat resistant layer and the like. A separator having an inorganic layer formed on one surface of a porous resin film can also be used. The inorganic layer is typically composed of inorganic particles and a binder and may contain other components.

The inorganic layer may be disposed on a surface facing the positive electrode, may be disposed on a surface facing the negative electrode, or may be disposed on both surfaces. In general, the inorganic layer is preferably disposed on a surface facing the positive electrode in order to suppress modification due to an action from the positive electrode. On the other hand, in an energy storage device in which the negative active material contains lithium metal, the inorganic layer is preferably disposed on a surface facing the negative electrode in order to reduce possibility of a short circuit due to precipitation of metal lithium. Therefore, it may be preferable that the inorganic layers are disposed on both surfaces.

### Specific Configuration of Energy Storage Device

The shape of the energy storage device of the present embodiment is not particularly limited, and examples thereof include cylindrical batteries, pouch film batteries, prismatic batteries, flat batteries, coin batteries and button batteries.

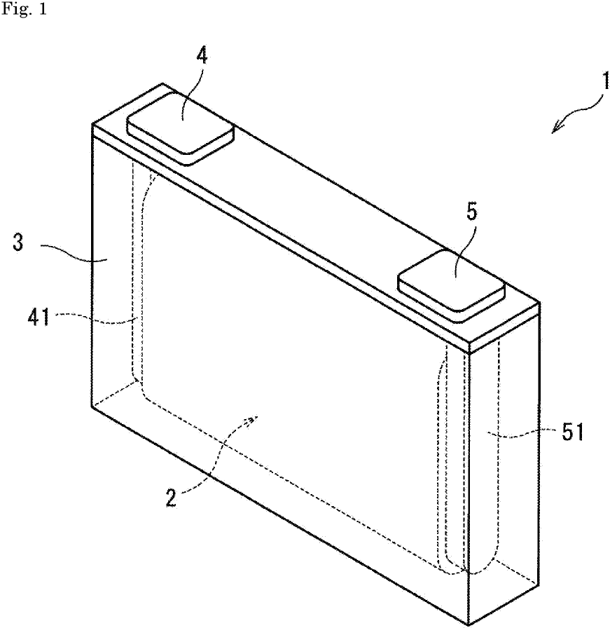

FIG. 1 shows an energy storage device 1 as an example of a prismatic battery. FIG. 1 is a view showing an inside of a case 3 in a perspective manner. An electrode assembly 2 having a positive electrode and a negative electrode which are wound with a separator interposed therebetween is housed in a prismatic case 3. The positive electrode is electrically connected to a positive electrode terminal 4 through a positive electrode lead 41. The negative electrode is electrically connected to a negative electrode terminal 5 via a negative electrode lead 51. A nonaqueous electrolyte is injected in the case 3.

### Method for Manufacturing Energy Storage Device

The energy storage device can be manufactured by a known method except for using the positive active material as the positive active material. A method for manufacturing the energy storage device according to the present embodiment can be appropriately selected from known methods. The method for manufacturing the energy storage device includes, for example, a step of preparing an electrode assembly, a step of preparing a nonaqueous electrolyte solution, and a step of housing the electrode assembly and the nonaqueous electrolyte solution in a case. The step of preparing an electrode assembly includes a step of preparing a positive electrode and a negative electrode and a step of forming an electrode assembly by stacking or winding the positive electrode and the negative electrode with a separator interposed therebetween.

In the step of housing the nonaqueous electrolyte solution in a case, the method can be appropriately selected from known methods. For example, when a liquid nonaqueous electrolyte solution is used, the nonaqueous electrolyte solution may be injected from an inlet formed in the case, followed by sealing the inlet. The details of the respective other elements configuring the energy storage device obtained by the method for manufacturing the energy storage device are as described above.

### Other Embodiments

The energy storage device according to the present invention is not limited to the embodiments described above, and various changes may be made without departing from the scope of the present invention. For example, the configuration according to one embodiment can be added to the configuration according to another embodiment, or a part of the configuration according to one embodiment can be replaced with the configuration according to another embodiment or a well-known technique. Furthermore, a part of the configuration according to one embodiment can be removed. In addition, a well-known technique can be added to the configuration according to one embodiment.

In the above embodiment, the energy storage device is a nonaqueous electrolyte solution secondary battery, but other energy storage devices may be used. Examples of the other energy storage devices include capacitors (electric double-layer capacitors and lithium ion capacitors). Examples of the nonaqueous electrolyte solution secondary battery include a lithium ion nonaqueous electrolyte solution secondary battery.

### Energy Storage Apparatus

The energy storage apparatus according to an embodiment of the present invention is an energy storage apparatus including a plurality of energy storage devices and including one or more of the energy storage devices of the present invention described above. An energy storage unit can be constituted using one or a plurality of energy storage devices (cells) of the present invention, and an energy storage apparatus can be constituted using the energy storage unit. The energy storage apparatus can be used as a power source for a motor vehicle, such as an electric vehicle (EV), a hybrid vehicle (HEV), or a plug-in hybrid vehicle (PHEV). The energy storage apparatus can be used for various power source apparatuses such engine starting power source apparatuses, auxiliary power source apparatuses, and uninterruptible power systems (UPSs).

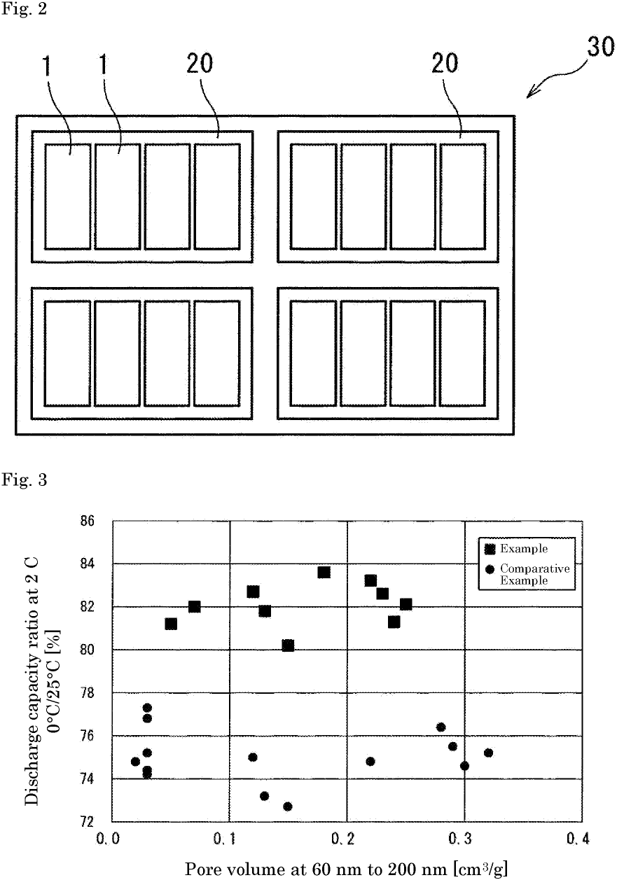

FIG. 2 illustrates an example of an energy storage apparatus 30 formed by assembling energy storage units 20 in each of which two or more electrically connected energy storage devices 1 are assembled. The energy storage apparatus 30 may include a busbar (not illustrated) for electrically connecting two or more energy storage devices 1 and a busbar (not illustrated) for electrically connecting two or more energy storage units 20. The energy storage unit 20 or the energy storage apparatus 30 may include a state monitor (not illustrated) for monitoring the state of one or more energy storage devices.

### EXAMPLES

Hereinafter, the present invention will be described in more detail with reference to Examples, but the present invention is not limited to the following Examples.

### Examples 1-1 to 1-10 and Comparative Examples 1-1 to 1-14

### Preparation of Positive Active Material

### Preparation of LiFePO₄ (Examples 1-1 to 1-6 and Comparative Examples 1-1 to 1-8)

While a 1 mol/dm³ aqueous FeSO₄ solution was added dropwise at a constant rate to a 2 dm³ reaction case containing 750 cm³ of ion-exchanged water, a 4 mol/dm³ aqueous NaOH solution, a 0.5 mol/dm³ aqueous NH₃ solution, and a 0.5 mol/dm³ aqueous NH₂NH₂ solution were added dropwise so that the pH during that time maintained each constant value shown in Table 1, thereby preparing a Fe(OH)₂ precursor. It is to be noted that the pH was adjusted without adding an aqueous NH₃ solution in Comparative Example 1-2, and without adding an aqueous NH₂NH₂ solution in Comparative Example 1-3, Comparative Example 1-4, Comparative Example 1-10, and Comparative Example 1-13. Next, the prepared Fe(OH)₂ precursor was solid-phase mixed with LiH₂PO₄ and sucrose powder. Then, the positive active material LiFePO₄ having an olivine-type crystal structure was prepared by firing at a firing temperature shown in Table 1 under a nitrogen atmosphere.

### Preparation of LiFe_{0.5}Mn₀.₅PO₄ (Examples 7 and 8, and Comparative Examples 9 to 11)

While an aqueous solution in which FeSO₄ and MnSO₄ were adjusted to have a molar ratio of 1 : 1 and a total of 1 mol/dm³ was added dropwise at a constant rate to a 2 dm³ reaction case containing 750 cm³ of ion-exchanged water, a 4 mol/dm³ aqueous NaOH solution, a 0.5 mol/dm³ aqueous NH₃ solution, and a 0.5 mol/dm³ aqueous NH₂NH₂ solution were added dropwise so that the pH during that time maintained each constant value shown in Table 1, thereby preparing a Fe_{0.5}Mn_{0.5}(OH)₂ precursor. Next, the prepared Fe_{0.5}Mn_{0.5}(OH)₂ precursor was solid-phase mixed with LiH₂PO₄ and sucrose powder. Then, the positive active material LiFe_{0.5}Mn_{0.5}PO₄ having an olivine-type crystal structure was prepared by firing at a firing temperature shown in Table 1 under a nitrogen atmosphere.

### Preparation of LiFe_{0.25}Mn_{0.75}PO₄ (Examples 1-9 and 1-10, and Comparative Examples 1-12 to 1-14)

While an aqueous solution in which FeSO₄ and MnSO₄ were adjusted to have a molar ratio of 1 : 3 and a total of 1 mol/dm³ was added dropwise at a constant rate to a 2 dm³ reaction case containing 750 cm³ of ion-exchanged water, a 4 mol/dm³ aqueous NaOH solution, a 0.5 mol/dm³ aqueous NH₃ solution, and a 0.5 mol/dm³ aqueous NH₂NH₂ solution were added dropwise so that the pH during that time maintained a constant value, thereby preparing a Fe_{0.25}Mn_{0.75}(OH)₂ precursor. Next, the prepared Fe_{0.25}Mn_{0.75}(OH)₂ precursor was solid-phase mixed with LiH₂PO₄ and sucrose powder. Then, the positive active material LiFe_{0.25}Mn_{0.75}PO₄ having an olivine-type crystal structure was prepared by firing at a firing temperature shown in Table 1 under a nitrogen atmosphere.

Table 1 shows values of x of the positive active materials of Examples 1-1 to 1-10 and Comparative Examples 1-1 to 1-14, pH at the time of preparing the precursor, heat treatment temperature, pore volume in the range of a pore size of 60 nm or more and 200 nm or less, and pore specific surface area in the range of a pore size of 10 nm or more and 200 nm or less. The pore volume and the pore specific surface area were measured based on the above method.

### Fabrication of Positive Electrode

N-Methylpyrrolidone (NMP) was used as a dispersion medium, and the positive active material, acetylene black as a conductive agent and PVdF as a binder were used. An appropriate amount of NMP was added to a mixture obtained by mixing the positive active material, the conductive agent and the binder at a mass ratio of 90 : 5 : 5 to adjust the viscosity, thereby preparing a positive composite paste. Next, the positive composite paste was applied to both surfaces of an aluminum foil as a positive electrode substrate, leaving an unapplied portion (positive active material layer non-forming portion), dried at 120° C., and roll-pressed to form a positive composite layer on the positive electrode substrate. The amount of the positive composite paste applied was set to 10 mg/cm² in terms of solid content. In this way, positive electrodes of Examples 1-1 to 1-10 and Comparative Examples 1-1 to 1-14 were obtained.

### Fabrication of Negative Electrode

Graphite as a negative active material, SBR as a binder, and CMC as a thickener were used. An appropriate amount of water was added to a mixture obtained by mixing the negative active material, the binder and the thickener at a mass ratio of 97 : 2 : 1 to adjust the viscosity, thereby preparing a negative composite paste. The negative composite paste was applied to both surfaces of a copper foil as a negative electrode substrate, leaving an unapplied portion (negative active material layer non-forming portion), and dried to prepare a negative active material layer. Thereafter, roll pressing was performed to fabricate a negative electrode.

### Preparation of Nonaqueous Electrolyte

LiPF₆ was dissolved at a concentration of 1 mol/dm³ in a mixed solvent in which EC and EMC were mixed at a volume ratio of 3 : 7 to prepare a nonaqueous electrolyte.

### Fabrication of Energy Storage Device

Next, the positive electrode and the negative electrode were laminated via a separator made of a polyethylene substrate and an inorganic layer formed on the polyethylene substrate to prepare an electrode assembly. The inorganic layer was disposed on a surface facing the positive electrode. The electrode assembly was housed into an aluminum prismatic container case, and a positive electrode terminal and a negative electrode terminal were attached. The nonaqueous electrolyte was injected into the case (prismatic container can), and then the case was sealed to obtain the energy storage devices of Examples 1-1 to 1-10 and Comparative Examples 1-1 to 1-14.

### Capacity Confirmation Test

For each of the energy storage devices, constant current charge was performed at 25° C. to 3.6 V at a charge current of 0.1 C, and then constant voltage charge was performed at 3.6 V. With regard to the charge termination conditions, charge was performed until the charge current reached 0.02 C. After charge, a pause of 10 minutes was provided, and then constant current discharge was performed at 25° C. to 2.0 V at a discharge current of 0.1 C. After discharge, a pause of 10 minutes was provided. The above cycle was repeated twice, and the second discharge capacity was set to 0.1 C capacity.

### Low-Temperature High-Rate Discharge Performance Test: Discharge Capacity Ratio

For each of the energy storage devices, constant current charge was performed at 25° C. to 3.6 V at a charge current of 0.1 C, and then constant voltage charge was performed at 3.6 V. With regard to the charge termination conditions, charge was performed until the charge current reached 0.02 C. After charge, a pause of 10 minutes was provided, and then constant current discharge was performed at 25° C. to 2.0 V at a discharge current of 2 C to measure “2 C discharge capacity at 25° C.”. Next, constant current charge was performed at 25° C. to 3.6 V at a charge current of 0.1 C, and then constant voltage charge was performed at 3.6 V. With regard to the charge termination conditions, charge was performed until the charge current reached 0.02 C. Thereafter, a pause period of 10 minutes was provided. Thereafter, constant current discharge was performed at 0° C. to 2.0 V at a discharge current of 2 C to measure “2 C discharge capacity at 0° C.”.

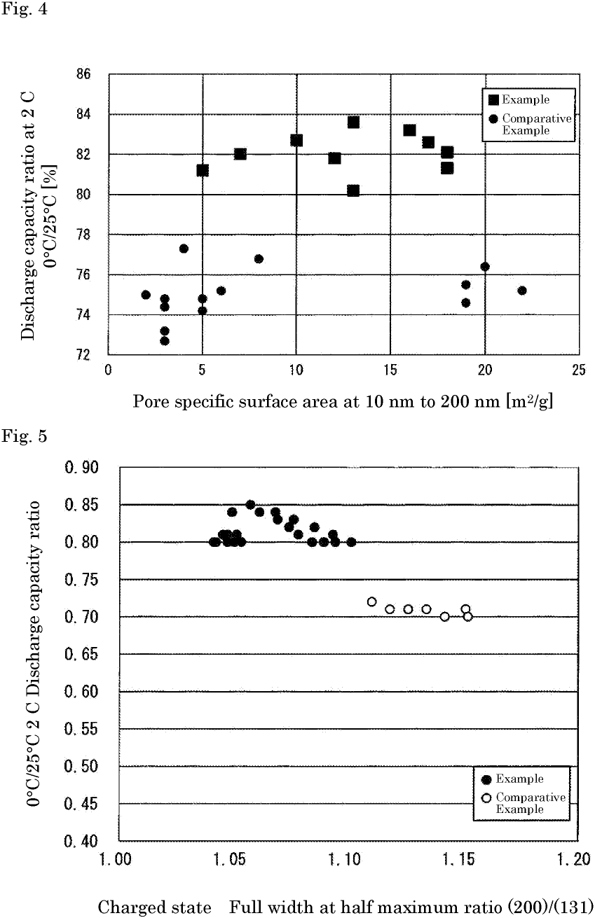

From the 2 C discharge capacity at 25° C. and the 2 C discharge capacity at 0° C., a “discharge capacity ratio”, that is, a percentage of the 2 C discharge capacity at 0° C. to the 2 C discharge capacity at 25° C. was determined as an index indicating low-temperature high-rate discharge performance. The values are shown in Table 1. Also, FIG. 3 shows a relationship between the pore volume and the discharge capacity ratio in the range of a pore size of 60 nm or more and 200 nm or less, and FIG. 4 shows a relationship between the pore specific surface area and the discharge capacity ratio in the range of a pore size of 10 nm or more and 200 nm or less.

The results of the low-temperature high-rate discharge performance test are shown in Table 1.

TABLE 1

| | Synthesis conditions of LiFeₓMn₍₁₋ₓ₎PO₄ | | | Positive active material | | Evaluation |
|---|---|---|---|---|---|---|
| | Value of x in formula 1 | Precursor pH | Heat treatment temperature [°C] | Pore volume at 60 nm to 200 nm [cm³/g] I | Pore specific surface area at 10 nm to 200 nm [m2/g] | Discharge capacity ratio 0° C./25° C. at 2 C [%] |
| Example 1-1 | 1 | 10.0 | 625 | 0.25 | 18 | 82.1% |
| Example 1-2 | 1 | 10.0 | 650 | 0.22 | 16 | 83.2%. |
| Example 1-3 | 1 | 10.0 | 675 | 0.18 | 13 | 83.6% |
| Example 1-4 | 1 | 10.0 | 700 | 0.12 | 10 | 82.7% |
| Example 1-5 | 1 | 10.0 | 725 | 0.07 | 7 | 82.0% |
| Example 1-6 | 1 | 10.5 | 700 | 0.05 | 5 | 81.2% |
| Example 1-7 | 0.5 | 10.0 | 650 | 0.23 | 17 | 82.6% |
| Example 1-8 | 0.5 | 10.0 | 700 | 0.13 | 12 | 81.8% |
| Example 1-9 | 0.25 | 10.0 | 650 | 0.24 | 18 | 81.3% |
| Example 1-10 | 0.25 | 10.0 | 700 | 0.15 | 13 | 80.2% |
| Comparative Example 1-1 | 1 | 12.0 | 700 | 0.03 | 4 | 77.3% |
| Comparative Example 1-2 | 1 | 10.0 | 700 | 0.03 | 3 | 74.4% |
| Comparative Example 1-3 | 1 | 10.0 | 650 | 0.22 | 3 | 74.8% |
| Comparative Example 1-4 | 1 | 10.0 | 700 | 0.12 | 2 | 75.0% |
| Comparative Example 1-5 | 1 | 10.0 | 580 | 0.32 | 22 | 75.2% |
| Comparative Example 1-6 | 1 | 10.0 | 600 | 0.28 | 20 | 76.4% |
| Comparative Example 1-7 | 1 | 10.0 | 750 | 0.03 | 8 | 76.8% |
| Comparative Example 1-8 | 1 | 10.0 | 770 | 0.02 | 5 | 74.8% |
| Comparative Example 1-9 | 0.5 | 10.0 | 600 | 0.29 | 19 | 75.5% |
| Comparative Example 1-10 | 0.5 | 10.0 | 700 | 0.13 | 3 | 73.2% |
| Comparative Example 1-11 | 0.5 | 10.0 | 750 | 0.03 | 6 | 75.2% |
| Comparative Example 1-12 | 0.25 | 10.0 | 600 | 0.30 | 19 | 74.6% |
| Comparative Example 1-13 | 0.25 | 10.0 | 600 | 0.15 | 3 | 72.7% |
| Comparative Example 1-14 | 0.25 | 10.0 | 750 | 0.03 | 5 | 74.2% |

As shown in Table 1, FIG. 3 and FIG. 4, it can be seen that in Examples 1-1 to 1-10 in which the positive active material has an olivine-type crystal structure and has a surface at least partially coated with carbon, the pore volume in the range of a pore size of 60 nm or more and 200 nm or less determined by a BJH method from a desorption isotherm using a nitrogen gas adsorption method is 0.05 cm³/g or more and 0.25 cm³/g or less, and the pore specific surface area in the range of a pore size of 10 nm or more and 200 nm or less using a nitrogen gas adsorption method is 5 m²/g or more, the capacity during high rate discharge in a low temperature environment is larger than that in Comparative Examples 1-1 to 1-12.

In addition, comparison of the discharge capacity ratios among LiFePO₄ (x = 1), LiFe_{0.5}Mn_{0.5}PO₄ (x = 0.5) and LiFe_{0.25}Mn_{0.75}PO₄ (x = 0.25) as positive active materials shows that the larger the pore specific surface area in the pore size range of 10 nm or more and 200 nm or less, the higher the discharge capacity ratio. When the positive active material was LiFePO₄ (x = 1), the discharge capacity ratio was particularly excellent when the pore specific surface area was 10 m²/g or more.

As a result, it was shown that the positive active material satisfying the (A) above can increase the capacity of the energy storage device during high rate discharge in a low temperature environment.

### Examples 2-1 to 2-22 and Comparative Examples 2-1 to 2-7

### Preparation of Positive Active Material

### Preparation of LiFePO₄ (Examples 2-1 to 2-14 and Comparative Examples 2-1 to 2-5)

While a 1 mol/dm³ aqueous FeSO₄ solution was added dropwise at a constant rate to a 2 dm³ reaction case containing 750 cm³ of ion-exchanged water, a 4 mol/dm³ aqueous NaOH solution, an aqueous NH₃ solution at a concentration shown in Table 2, and a 0.5 mol/dm³ aqueous NH₂NH₂ solution were added dropwise so that the pH during that time maintained a constant value, thereby preparing a Fe(OH)₂ precursor. In Comparative Examples 2-1, 2-6 and 2-7, the pH was adjusted without adding an aqueous NH₃ solution. Next, the prepared Fe(OH)₂ precursor was solid-phase mixed with LiH₂PO₄ and sucrose powder. The carbon coating amount was set to 1% by mass with respect to the total mass of the positive active material for all of Examples 2-1 to 2-22 and Comparative Examples 2-1 to 2-7. Then, the positive active material LiFePO₄ having an olivine-type crystal structure was prepared by firing at a firing temperature shown in Table 2 under a nitrogen atmosphere.

### Preparation of LiFe_{0.5}Mn_{0.5}PO₄ (Examples 2-15 to 2-18 and Comparative Example 2-6)

While an aqueous solution in which FeSO₄ and MnSO₄ were adjusted to have a molar ratio of 1 : 1 and a total of 1 mol/dm³ was added dropwise at a constant rate to a 2 dm³ reaction case containing 750 cm³ of ion-exchanged water, a 4 mol/dm³ aqueous NaOH solution, an aqueous NH₃ solution at a concentration shown in Table 2, and a 0.5 mol/dm³ aqueous NH₂NH₂ solution were added dropwise so that the pH during that time maintained a constant value, thereby preparing a Fe_{0.5}Mn_{0.5}(OH)₂ precursor. Next, the prepared Fe_{0.5}Mn_{0.5}(OH)₂ precursor was solid-phase mixed with LiH₂PO₄ and sucrose powder. Then, the positive active material LiFe_{0.5}Mn_{0.5}PO₄ having an olivine-type crystal structure was prepared by firing at a firing temperature shown in Table 2 under a nitrogen atmosphere.

### Preparation of LiFe_{0.25}Mn_{0.75}PO₄ (Examples 2-19 to 2-22 and Comparative Example 2-7)

While an aqueous solution in which FeSO₄ and MnSO₄ were adjusted to have a molar ratio of 1 : 3 and a total of 1 mol/dm³ was added dropwise at a constant rate to a 2 dm³ reaction case containing 750 cm³ of ion-exchanged water, a 4 mol/dm³ aqueous NaOH solution, an aqueous NH₃ solution at a concentration shown in Table 2, and a 0.5 mol/dm³ aqueous NH₂NH₂ solution were added dropwise so that the pH during that time maintained a constant value, thereby preparing a Fe_{0.25}Mn_{0.75}(OH)₂ precursor. Next, the prepared Fe_{0.25}Mn_{0.75}(OH)₂ precursor was solid-phase mixed with LiH₂PO₄ and sucrose powder. Then, the positive active material LiFe_{0.25}Mn_{0.75}PO₄ having an olivine-type crystal structure was prepared by firing at a firing temperature shown in Table 2 under a nitrogen atmosphere.

Table 2 shows values of x of the positive active materials of Examples 2-1 to 2-22 and Comparative Examples 2-1 to 2-7, NH₃ concentration, firing temperature, the full width at half maximum ratio (200)/(131) of a peak by a powder X-ray diffraction method using a CuKa ray in a charged state, and the full width at half maximum of a peak corresponding to the (131) plane by the powder X-ray diffraction method using a CuKa ray in a discharged state. The full width at half maximum of the peak was measured based on the above method.

Using the positive active materials of Examples 2-1 to 2-22 and Comparative Examples 2-1 to 2-7, energy storage devices of Examples 2-1 to 2-22 and Comparative Examples 2-1 to 2-7 were obtained in the same procedure as in Example 1-1.

### Capacity Confirmation Test

Under the same conditions as described above, a capacity confirmation test was performed, and 0.1 C capacity was measured.

### Low-Temperature High-Rate Discharge Performance Test: Discharge Capacity Ratio

A low-temperature high-rate discharge performance test was performed under the same conditions as described above, the “2 C discharge capacity at 25° C.” and the “2 C discharge capacity at 0° C.” were measured, and the “discharge capacity ratio” was determined. The values are shown in Table 2. FIG. 5 shows a relationship between the full width at half maximum ratio (200)/(131) of the peak of the positive active material and the discharge capacity ratio, and FIG. 5 shows a relationship between the full width at half maximum of the peak corresponding to the (131) plane of the positive active material and the discharge capacity ratio.

### Low-Temperature Power Performance Test

The energy storage devices of Examples 2-1 to 2-22 and Comparative Examples 2-1 to 2-7 after one cycle of the capacity confirmation test were stored in a thermostatic bath at 25° C. for 3 hours, then constant current charge was performed at a charge current of 0.1 C to a voltage at which the SOC (State of Charge) was 50%, and then constant voltage charge was performed at a voltage at which the SOC was 50%. With regard to the charge termination conditions, charge was performed until the charge current reached 0.02 C. Thereafter, in each of thermostatic baths at 0° C. and 25° C., power at 1 second of energization was measured by IV method. The ratio of the measured value of power at 0° C. to the measured value of power at 25° C. was calculated as a “power ratio”.

The results of the low-temperature high-rate discharge performance test and the low-temperature power performance test are shown in Table 2.

TABLE 2

| | Synthesis conditions of LiFeₓMn₍₁₋ₓ)PO₄ | | | Positive active material | | Evaluation | |
|---|---|---|---|---|---|---|---|
| | Value of x in formula 1 | NH₃ Concentration [mol/dm³] | Heat treatment temperature [°C] | Charged state Full width at half maximum ratio (200)/(131) ratio | Discharged state Full width at half maximum of (131) plane [degree] | Discharge capacity ratio 0° C./25° C. at 2 C [%] | 0° C./25° C. Power ratio |
| Example 2-1 | 1 | 0.5 | 580 | 1.08 | 0.167 | 0.80 | 0.72 |
| Example 2-2 | 1 | 0.5 | 600 | 1.08 | 0.161 | 0.81 | 0.74 |
| Example 2-3 | 1 | 0.5 | 625 | 1.07 | 0.155 | 0.82 | 0.81 |
| Example 2-4 | 1 | 0.5 | 650 | 1.07 | 0.146 | 0.83 | 0.82 |
| Example 2-5 | 1 | 0.5 | 675 | 1.06 | 0.137 | 0.84 | 0.84 |
| Example 2-6 | 1 | 0.5 | 700 | 1.06 | 0.124 | 0.85 | 0.85 |
| Example 2-7 | 1 | 0.5 | 725 | 1.05 | 0.110 | 0.84 | 0.83 |
| Example 2-8 | 1 | 0.5 | 750 | 1.05 | 0.107 | 0.81 | 0.74 |
| Example 2-9 | 1 | 0.5 | 770 | 1.04 | 0.104 | 0.80 | 0.73 |
| Example 2-10 | 1 | 0.25 | 700 | 1.10 | 0.124 | 0.80 | 0.80 |
| Example 2-11 | 1 | 0.3 | 700 | 1.09 | 0.124 | 0.81 | 0.81 |
| Example 2-12 | 1 | 0.35 | 700 | 1.09 | 0.124 | 0.82 | 0.82 |
| Example 2-13 | 1 | 0.4 | 700 | 1.08 | 0.124 | 0.83 | 0.83 |
| Example 2-14 | 1 | 0.45 | 700 | 1.07 | 0.124 | 0.84 | 0.84 |
| Example 2-15 | 0.5 | 0.5 | 600 | 1.09 | 0.167 | 0.80 | 0.72 |
| Example 2-16 | 0.5 | 0.5 | 650 | 1.05 | 0.150 | 0.80 | 0.80 |
| Example 2-17 | 0.5 | 0.5 | 700 | 1.05 | 0.126 | 0.81 | 0.82 |
| Example 2-18 | 0.5 | 0.5 | 750 | 1.05 | 0.108 | 0.80 | 0.71 |
| Example 2-19 | 0.25 | 0.5 | 600 | 1.09 | 0.168 | 0.80 | 0.71 |
| Example 2-20 | 0.25 | 0.5 | 650 | 1.05 | 0.155 | 0.80 | 0.80 |
| Example 2-21 | 0.25 | 0.5 | 700 | 1.05 | 0.130 | 0.81 | 0.81 |
| Example 2-22 | 0.25 | 0.5 | 750 | 1.04 | 0.108 | 0.80 | 0.70 |
| Comparative Example 2-1 | 1 | 0 | 700 | 1.14 | 0.124 | 0.70 | 0.70 |
| Comparative Example 2-2 | 1 | 0.05 | 700 | 1.13 | 0.124 | 0.71 | 0.71 |
| Comparative Example 2-3 | 1 | 0.1 | 700 | 1.13 | 0.124 | 0.71 | 0.71 |
| Comparative Example 2-4 | 1 | 0.15 | 700 | 1.12 | 0.124 | 0.71 | 0.72 |
| Comparative Example 2-5 | 1 | 0.2 | 700 | 1.11 | 0.124 | 0.72 | 0.72 |
| Comparative Example 2-6 | 0.5 | 0 | 700 | 1.15 | 0127 | 0.71 | 0.69 |
| Comparative Example 2-7 | 0.25 | 0 | 700 | 1.15 | 0.127 | 0.70 | 0.68 |

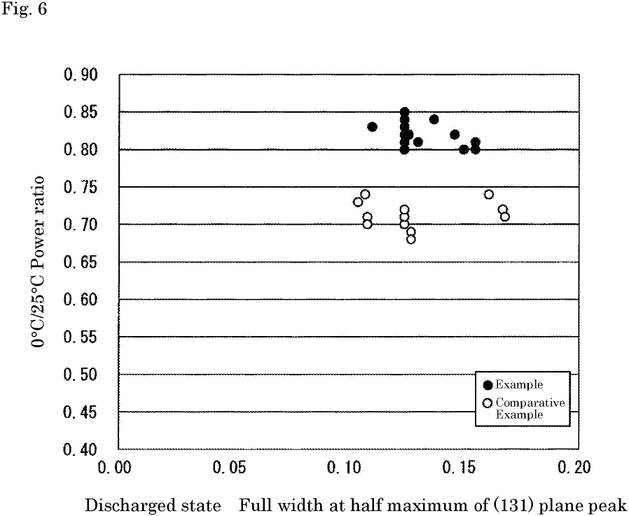

As shown in Table 2, FIG. 5 and FIG. 6, it can be seen that Examples 2-1 to 2-22 in which the positive active material has an olivine-type crystal structure and has a surface at least partially coated with carbon, and the full width at half maximum ratio (200)/(131) of a peak corresponding to the (200) plane to a peak corresponding to the (131) plane by a powder X-ray diffraction method using a CuKa ray in a charged state is 1.10 or less have an excellent discharge capacity ratio at 0° C. to 25° C. as compared with Comparative Examples 2-1 to 2-7.

In addition, it can be seen that Examples 2-3 to 2-7, Examples 2-10 to 2-14, Example 2-16, Example 2-17, Example 2-20 and Example 2-21 in which the full width at half maximum of the peak corresponding to the (131) plane by a powder X-ray diffraction method using a CuKa ray is 0.110 or more and 0.155 or less in a discharged state of the positive active material are also excellent in the power ratio at 0° C. to 25° C.

As a result, it was shown that the positive active material satisfying the (B) above can increase the capacity of the energy storage device during high rate discharge in a low temperature environment.

### INDUSTRIAL APPLICABILITY

The present invention can be applied to an energy storage device used as a power source for electronic devices such as personal computers and communication terminals, motor vehicles, and the like.

### DESCRIPTION OF REFERENCE SIGNS

1: energy storage device
2: electrode assembly
3: case
4: positive electrode terminal
41: positive electrode lead
5: negative electrode terminal
51: negative electrode lead
20: energy storage unit
30: energy storage apparatus

1. A positive active material for an energy storage device,
having an olivine-type crystal structure,
having a surface at least partially coated with carbon, and
satisfying either (A) or (B) below:
(A) a pore volume in a range of a pore size of 60 nm or more and 200 nm or less determined by a BJH method from a desorption isotherm using a nitrogen gas adsorption method is 0.05 cm³/g or more and 0.25 cm³/g or less, and a pore specific surface area in a range of a pore size of 10 nm or more and 200 nm or less using a nitrogen gas adsorption method is 5 m²/g or more;
(B) a full width at half maximum ratio (200)/(131) of a peak corresponding to a (200) plane to a peak corresponding to a (131) plane by a powder X-ray diffraction method using a CuKα ray in a charged state is 1.10 or less.

2. The positive active material for an energy storage device according to claim 1, wherein
the positive active material satisfies the (B), and
a full width at half maximum of a peak corresponding to the (131) plane by a powder X-ray diffraction method using a CuKα ray in a discharged state is 0.110 or more and 0.155 or less.

3. The positive active material for an energy storage device according to claim 1, wherein the positive active material is a compound represented by formula 1 below:
$${\text{LiFe}}_{\text{x}} {\text{Mn}}_{\left(1 - \text{x}\right)} {\text{PO}}_{4} \left(0 \leq \text{x} \leq \text{1}\right)$$
.

4. A positive electrode for an energy storage device, comprising the positive active material according to claim 1.

5. An energy storage device comprising the positive electrode according to claim 4.

6. An energy storage apparatus comprising a plurality of energy storage devices and comprising one or more of the energy storage devices according to claim 5.
